(19) United States
(12) Patent Application Publication
(10) Pub. No.: US 2014/0240990 A1
(43) Pub. Date: Aug. 28, 2014

(54) LED LIGHTING DEVICE

(71) Applicant: Young Su Bae, Ansan-si (KR)

(72) Inventor: Young Su Bae, Ansan-si (KR)

(73) Assignees: HUNIX, Ansan-si, Gyeonggi-do (KR); Young Su BAE, Ansan-si, Gyeonggi-do (KR)

(21) Appl. No.: 14/347,972

(22) PCT Filed: Sep. 30, 2011
(86) PCT No.: PCT/KR2011/007259

§ 371 Date: Mar. 27, 2014

(30) Foreign Application Priority Data
Sep. 27, 2011 (KR) 10-2011-0097271

(51) Int. Cl. F21V 29/00; F21K 99/00

(52) U.S. Cl. CPC F21V 29/22; F21K 9/135
USPC 362/294; 362/373

(57) ABSTRACT

The present invention relates to an LED lighting device comprising: a power case main body wherein one side is opened to form a receiving space inside, and a lamp terminal is provided to be electrically connected to a lamp socket on an end of the other side; a main body heat sink which surrounds a part or most of an outer circumference of the power case main body, and is combined to one side of the open power case main body; a plurality of lamp heat sinks which are protruded and combined to contact one side of the main body heat sink to conduct heat with the main body heat sink and forms a radiation structure around a central shaft formed according to a protruded direction; and a main LED module which contacts and is combined to an outer side end in a radiation direction of the lamp heat sink to conduct the heat with the lamp heat sink.

### TECHNICAL FIELD

The present invention relates to an LED lighting device, and more particularly, to an LED lighting device in which a lamp heat sink having a radial structure is disposed on the rear side of LED light-emitting surfaces and a case body heat sink is disposed to wholly or partially encircle the outer peripheral surface of the power case body to maximize the heat dissipation function, thereby implementing a compact distributional LED lighting device with remarkably reduced size, and in which LEDs are disposed to secure a sufficient light-emitting surface so that light emitted from the LEDs can be diffused in various directions and light with uniform luminance can be irradiated onto a large area.

### BACKGROUND ART

Lighting fittings that is currently used widely include an incandescent lamp, a fluorescent lamp, a three-wavelength light bulb, and the like. These lighting fittings are widely used by general consumers owing to simplicity of production and use. However, the conventional lighting fittings entail problems in that their lifespan is short and much power is consumed, leading to an increase in energy cost, and in that the lighting fittings emit UV rays harmful to the human body or contain argon (Ar) gas, helium (He) gas and the like, causing a serious environmental issue.

In meantime, lightings employing LEDs having improved lifespan and excellent energy efficiency are developed in an attempt to replace such conventional lighting fittings. LEDs are light-emitting devices that are configured to allow current to flow through pn conjunctions of a semiconductor to emit light. Recently, an effort to use the LEDs as lighting devices is spreading all over the world beyond the applicable range as existing displays along with the rapid increase of the light-emitting efficiency of the LEDs such as blue, green, red, white, and amber. In particular, LEDs has a lot, of advantages in that it a considerably long lifespan, can maintain a light-emitting state with significantly low power for a long period of time, and the like. Therefore, technologies are being developed, which are capable of improving utilization of LEDs as lighting fittings.

In case of using LEDs as lighting fittings, however, there is involved a problem in that a heat dissipation structure of an LED lighting device is bulky and complicated due to high heat generated from the LEDs and light is not dispersed and diffused due to straightness of light emitted from the LEDs, causing a glare phenomenon. Thus, there are still problems in substituting for the demand for existing incandescent lamps and fluorescent lamps.

As a method for overcoming the above-mentioned problems, LED lighting fittings as substitutes for conventional incandescent lamps, three-wavelength light bulbs, and fluorescent lamps can employ a method in which LEDs are typically arranged on a light-emitting surface. In this case, however, pluralities of LEDs are required to be arranged on the overall light-emitting surface in order to secure a sufficient light-emitting surface. As such, in the case where the plurality of LEDs are arranged, there occurs a problem in that the performance of the LEDs are deteriorated due to heat generated from LEDs as described above, leading to a reduction in the lifespan of the LEDs or a damage to the LEDs. Therefore, lighting fittings employing LEDs that are currently used widely have a limitation in its use due to high heat generated from LEDs and a glare problem caused by straightness of light, and do not substitute for the demand for existing incandescent lamps, three-wavelength light bulbs, fluorescent lamps, and the like.

### DISCLOSURE OF INVENTION

### Technical Problem

Accordingly, the present invention has been made to solve the above-mentioned problems occurring in the prior art, and it is an object of the present invention to provide an LED lighting device in which a lamp heat sink having a radial structure is disposed on the rear side of LED light-emitting surfaces so as to be connected to a case body heat sink exposed to the outside to maximize the dissipation of heat generated from LED modules, and a case body heat sink is disposed to partially encircle the outer peripheral surface of the power case body to maximize the dissipation of heat generated from the LED module through the outer periphery of the case body heat sink, thereby implementing a compact distributional LED lighting device with remarkably reduced size.

An object of the present invention is to provide an LED lighting device in which LEDs are disposed to secure a sufficient light-emitting surface so that light emitted from the LED modules can be diffused in various directions, light with uniform luminance can be irradiated onto a large area, and the LED modules are all connected in series and in parallel with to each other, enabling easy control of the LED lighting device and improving assemblability.

Still another object of the present invention is to provide an LED lighting device which includes a separate light guide cap to prevent a glare phenomenon occurring due to light straightness and high brightness so that light emitted from LED modules can be diffusively dissipated with uniform luminance.

### Technical Solution

To achieve the above object, in one aspect, the present invention provides an LED lighting device including: a power case body opened at one end thereof to have an accommodation space defined therein and formed at the other end thereof with a lamp terminal; a case body heat sink coupled to the opened one end of the power case body in such a manner as to partially encircle the outer peripheral surface of the power case body; a lamp heat sink protrudingly coupled to the case body heat sink so as to be thermally conducted with the case body heat sink; and an LED module contactingly coupled to the lamp heat sink so as to be thermally conducted with the lamp heat sink.

In the LED lighting device, the lamp heat sink may be arranged to form a radial structure with respect to a central axis formed in a direction where the lamp heat sink is protruded from the case body heat sink, and the LED module may include a main LED module contactingly coupled to the outer ends of the lamp heat sink so as to be thermally conducted with the lamp heat sink.

In the LED lighting device, the lamp heat sink may include a contact plate arranged at the outer end thereof in a radial direction so as to allow the main LED module to be coupled to the contact plate while being surface-contacted with the contact plate.

In the LED lighting device, the contact plate may have a heat dissipation wing protrudingly formed on the inner surface thereof.

In the LED lighting device, the LED module may include an auxiliary LED module contactingly coupled to the lamp heat sink so as to be thermally conducted with the lamp heat sink, and the auxiliary LED module may be electrically connected with the main LED module.

In the LED lighting device, the main LED module and the auxiliary LED module may be formed integrally with each other using a single printed circuit board.

In the LED lighting device, the main LED module may include a main LED board coupled to the contact plate of the lamp heat sink while being surface-contacted with the contact plate and one or more main LED lamps mounted on the main LED board.

In the LED lighting device, the auxiliary LED module may include an auxiliary LED board contactingly coupled to the lamp heat sink and one or more auxiliary LED lamps mounted on the auxiliary LED board.

In the LED lighting device, the auxiliary LED board may be formed in any one of a flat panel shape, a circular shape, an annular shape, and a polygonal shape.

In the LED lighting device, the main LED board may include any one of a typical FR4 printed circuit board, a metal printed circuit board, a flexible printed circuit board, and a highly thermal conductive printed circuit board.

In the LED lighting device, the auxiliary LED board may include any one of a typical FR4 printed circuit board, a metal printed circuit board, a flexible printed circuit board, and a highly thermal conductive printed circuit board.

In the LED lighting device, a plurality of main LED module each coupled to the contact plate may be configured such that the main LED modules are electrically connected to each other by connection parts formed as a flexible printed circuit board or an electric wire.

In the LED lighting device, the main LED module may be provided in plural numbers, and the main LED modules each coupled to the contact plate are formed integrally with each other to include a single printed circuit board.

In the LED lighting device, the auxiliary LED module may be electrically connected to the main LED modules such that the auxiliary LED board is connected to any one of the main LED boards.

In the LED lighting device, a separate power supplying drive board may be mounted in an internal space of the power case body so as to be electrically connected to the lamp terminal, and the LED module may be engaged with the drive board so as to be electrically connected to the drive board.

Preferably, the LED lighting device may further include a light guide cap configured to encircle the outside surfaces of the lamp heat sink and the LED module.

Preferably, the LED lighting device may further include a light guide cap configured to encircle the outside surfaces of the main LED module and the auxiliary LED module.

In the LED lighting device, the light guide cap may include a main light guide cap engaged to the lamp heat sink to encircle the outer surface of the main LED module and an auxiliary light guide cap engaged to one end of the main light guide cap to encircle the outer surface of the auxiliary LED module.

In the LED lighting device, the main light guide cap and the auxiliary light guide cap may be formed separately from each other.

In the LED lighting device, the main light guide cap and the auxiliary light guide cap may be formed integrally with each other.

In the LED lighting device, the main LED module and the main light guide cap are provided in plural numbers, and each of the main light guide caps is engaged to the lamp heat sink.

In the LED lighting device, the light guide cap may be formed in an integral shape to wholly encircle the outer surfaces of the main LED modules and the auxiliary LED module.

In the LED lighting device, the light guide cap may have a ventilation hole formed at the center thereof or may be formed in a shape which is partially opened between adjacent main LED modules at a side thereof in a vertical direction thereof.

In the LED lighting device, the light guide cap may be formed in a flat-plate shape or a hemi-spherical shape which is opened at one end thereof and is closed at the other end thereof so as to be engaged with the case body heat sink.

In the LED lighting device, the case body heat sink and the lamp heat sink may be formed of any one of aluminum, magnesium, aluminum magnesium alloy, highly thermal conductive alloy, and highly thermal conductive resin.

In the LED lighting device, the case body heat sink may be formed integrally with the lamp heat sink so that heat generated from the LED module is conducted to the case body heat sink through the lamp heat sink to maximize the heat dissipation function.

In the LED lighting device, the case body heat sink may include: an engagement unit engaged to the power case body in such a manner as to partially encircle the outer peripheral surface of the power case body; a support unit disposed above the engagement unit in such a manner as to be spaced apart from the engagement unit and configured to support the lamp heat sink; and a heat dissipation wing unit arranged between the engagement unit and the support unit to improve the heat dissipation capacity.

Preferably, the LED lighting device may further include a light guide cap configured to encircle the outer surfaces of the lamp heat sink and the LED module so the light emitted from the LED module can be diffused with uniform luminance, wherein the light guide cap is made of any one of PC, acryl, nylon, PE, PEEK, and transparent PET resins.

In the LED lighting device, the light guide cap may further contain a diffusion agent.

In the LED lighting device, the light guide cap may include a light guide surface diffusing unit formed on the inner or outer surface thereof so that light emitted from the main LED module and the auxiliary LED module can be diffused with uniform luminance.

Preferably, the LED lighting device may further include a light guide cap configured to encircle the outer surfaces of the lamp heat sink and the LED module so that light emitted from the LED module can be diffused with uniform luminance, wherein the inner or outer surface of the light guide cap is coated with carbon nano tube (CNT), graphene, or ceramic to maximize a light dissipation function.

Preferably, the LED lighting device may further include a light guide cap configured to encircle the outer surfaces of the lamp heat sink and the LED module so that light emitted from the LED module can be diffused with uniform luminance, wherein the light guide cap is made of any one of PC, acryl, nylon, PE, PEEK, and transparent PET resins, and is further filled with a carbon nano tube (CNT) filler, a grapheme filler or a ceramic filler to maximize a light dissipation function.

Preferably, the LED lighting device may further include a light guide cap configured to encircle the outer surfaces of the lamp heat sink and the LED module so that light emitted from the LED module can be diffused with uniform luminance, wherein the lamp heat sink has a longitudinal structure in which it is connected to the case body heat sink so as to extend from one surface of the case body heat sink, and wherein the light guide cap has a longitudinal structure in which the light guide cap encircles the lamp heat sink in such a manner that the lamp heat sink is extendingly disposed inside the light guide cap.

### Advantageous Effects

According to the LED lighting device having the configuration as described above have the following advantageous effects.

A lamp heat sink having a radial structure is disposed on the rear side of LED light-emitting surfaces so as to be connected to a case body heat sink exposed to the outside to maximize the dissipation of heat generated from LED modules.

In addition, the case body heat sink is disposed to wholly or partially encircle the outer peripheral surface of the power case body to maximize the dissipation of heat generated from the LED module through the outer periphery of the case body heat sink.

In addition, the engagement structure between the lamp heat sink and the case body heat sink/the power case body maximizes the dissipation of heat generated from the LED modules so that the size of the LED lighting device can be remarkably reduced.

Moreover, a heat dissipation wing unit formed between an engagement unit of the case body heat sink to the power case body and a support unit of the case body heat sink to the lamp heat sink maximizes the dissipation of heat generated from the LED modules.

Besides, LEDs are disposed to secure a sufficient light-emitting surface so that light emitted from the LEDs can be diffused in various directions and light with uniform luminance can be irradiated onto a large area.

In addition, a plurality of LED modules are sequentially electrically connected to each other into a single line using a flexible printed circuit board, enabling easy control of the LED lighting device and improving assemblability.

Further, a separate light guide cap is provided to prevent a glare phenomenon occurring due to light straightness and high brightness so that light emitted from LED modules can be diffusively dissipated with uniform luminance.

In addition, the light guide cap is formed as an integral structure in which it is coupled to one side of the case body heat sink so as to encircle the outer surfaces of the main LED module and the auxiliary LED module, thereby improving assemblability of the device.

In addition, an integral light guide cap is formed in a shape in which it separately encircles the outer surface of each of the main LED modules and its lateral side is partially opened in a vertical direction so that external air is ventilated through a central portion of the light guide cap, thereby improving the heat dissipation capacity of the lamp heat sink.

Also, an light guide cap has a ventilation hole formed at the central portion thereof so as to allow external air to be ventilated therethrough, thereby improving the heat dissipation capacity of the lamp heat sink for dissipating heat generated from the plurality of LEDs modules.

In addition, the heat dissipation capacity of the lamp heat sink for dissipating heat generated from the LED modules can be maximized through the lamp heat sink connected to the case body heat sink while extending to the inside of the light guide cap.

Further, the externally exposed surface of the lamp heat sink can be minimized by the connection structure between the case body heat sink and the lamp heat sink, thereby implementing compactness of the LED lighting device.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic perspective view illustrating the outer appearance of an LED lighting device according to one embodiment of the present invention;

FIG. 2 is a partially exploded perspective view illustrating the inner coupled state of an LED lighting device according to one embodiment of the present invention;

FIG. 3 is a schematic exploded perspective view illustrating the configuration of an LED lighting device according to one embodiment of the present invention;

FIG. 4 is a cross-sectional view conceptually illustrating the inner structure of an LED lighting device according to one embodiment of the present invention;

FIG. 5 is a partial perspective view illustrating the coupled state of main and auxiliary LED modules an LED lighting device according to an embodiment of the present invention;

FIGS. 6 and 7 are schematic perspective views illustrating the outer appearance of an LED lighting device according to another embodiment of the present invention;

FIG. 8 is a partially exploded perspective view illustrating the shape of a light guide cap and the coupling state of an LED lighting device according to another embodiment of the present invention;

FIG. 9 is a partially exploded perspective view illustrating the inner coupled state of an LED lighting device according to another embodiment of the present invention;

FIG. 10 is a schematic perspective view illustrating a case body heat sink of an LED lighting device according to another embodiment of the present invention;

FIG. 11 is an exploded perspective view illustrating an LED lighting device according to another embodiment of the present invention;

FIG. 12 is a schematic perspective view illustrating a contact plate of an LED lighting device according to another embodiment of the present invention;

FIG. 13 is a partially exploded perspective view schematically illustrating an LED lighting device according to another embodiment of the present invention;

FIG. 14 is a partially exploded perspective view schematically illustrating an LED lighting device according to another embodiment of the present invention;

FIG. 15 is a developed view schematically illustrating an integral structure of a main LED module and auxiliary LED module, which can be applied to the LED lighting device of FIG. 13;

FIG. 16 is a partially exploded perspective view schematically illustrating an LED lighting device according to another embodiment of the present invention;

FIGS. 17 to 20 are assembled and exploded perspective views schematically illustrating other examples of an LED lighting device according to another embodiment of the present invention; and

FIGS. 21 to 23 are schematic perspective and cross-sectional views illustrating a surface treatment type of a light guide cap of an LED lighting device according to another embodiment of the present invention.

### BEST MODE FOR CARRYING OUT THE INVENTION

Now, preferred embodiments of a LED lighting device according to the present invention will be described hereinafter in detail with reference to the accompanying drawings.

Now, preferred embodiments of the present invention will be described hereinafter in detail with reference to the accompanying drawings. It should be noted that the same elements in the drawings are denoted by the same reference numerals although shown in different figures. In the following description, the detailed description on known function and constructures unnecessarily obscuring the subject matter of the present invention will be avoided hereinafter.

An LED lighting device according to one embodiment of the present invention is configured such that it has a sufficient light-emitting surface to allow light to be uniformly emitted to a wide area and simultaneously has a heat dissipation structure to prevent its damage due to generation of heat. The LED lighting device includes a power case body 100, a case body heat sink 200 and a lamp heat sink 300 that perform a heat dissipation function, and an LED module 400/500 that serves to emit light. The LED module 400/500 includes a main LED module 400. The LED module may include an auxiliary LED module 500 to variously change a light irradiation direction, if necessary. Although it has been described in this embodiment that the main LED module 400 mainly irradiates light in a radial direction and the auxiliary LED module 500 irradiates light in a longitudinal direction of the LED lighting device, various modifications can be made. In addition, the LED lighting device may further include a light guide cap 600 that is configured to encircle the outer surfaces of the main LED module 400 and the auxiliary LED module 500 to diffuse light.

The power case body 100 is opened at one end thereof to have an accommodation space defined therein and is formed at the other end thereof with a lamp terminal 110 so as to be electrically connected with a lamp socket (not shown). The lamp terminal 110 may be configured such that it has a screw thread formed on the outer peripheral surface thereof so as to be fastened to the lamp socket in a screw engagement manner. Such a fastening structure may be configured variously in the same manner as that employed in a general lamp. For example, the fastening structure may be configured in the same manner as that employed in a PAR type lamp, or may be configured such that the lamp terminal consists of two pins so as to be fittingly inserted into the lamp socket. In addition, the fastening structure of the lamp terminal 110 may be modified in various manners within a range of allowing for the engagement between the lamp terminal and the lamp socket, such as having the same manner as that used in a general MR type lamp, having a structure in which the lamp terminal is fastened to the lamp socket in a clip type, and the like.

As such, when the lamp terminal 110 is insertedly fastened to the lamp socket, the lamp socket and the lamp terminal 110 are electrically connected to each other so that electric power is supplied to the LED lighting device through the lamp terminal 110.

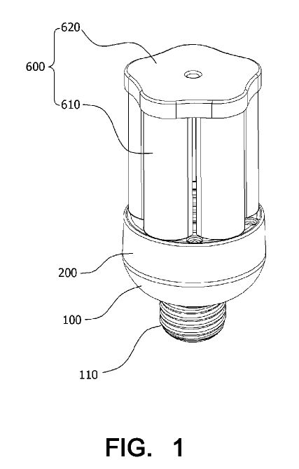

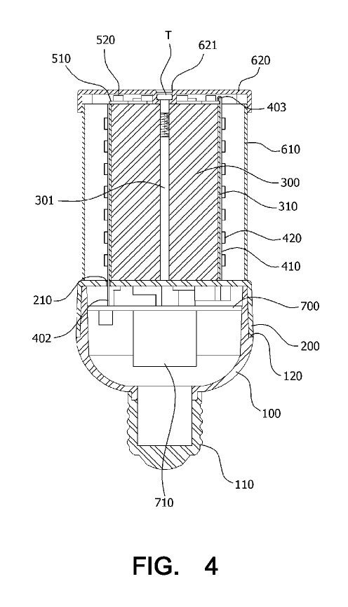

The case body heat sink 200 is configured to release heat generated from the LED lighting device. The case body heat sink 200 is preferably disposed so as to be exposed to the outside so that heat generated from elements such as a switched mode power supply (SMPS) 710 and the like (see FIG. 4) can be effectively released externally. The case body heat sink 200 according to the present invention at least partially encircles the power case body 100. That is, for example, as shown in FIGS. 1 to 3, the case body heat sink 200 can be coupled to the opened one end of the power case body 100 in such a manner as to partially encircle the outer peripheral surface of the power case body 100. The case body heat sink may have such a structure as to consist of a plurality of elements that can be coupled to each other (see FIGS. 19 and 20). The engagement and disengagement structure of the case body heat sink will be described hereinafter.

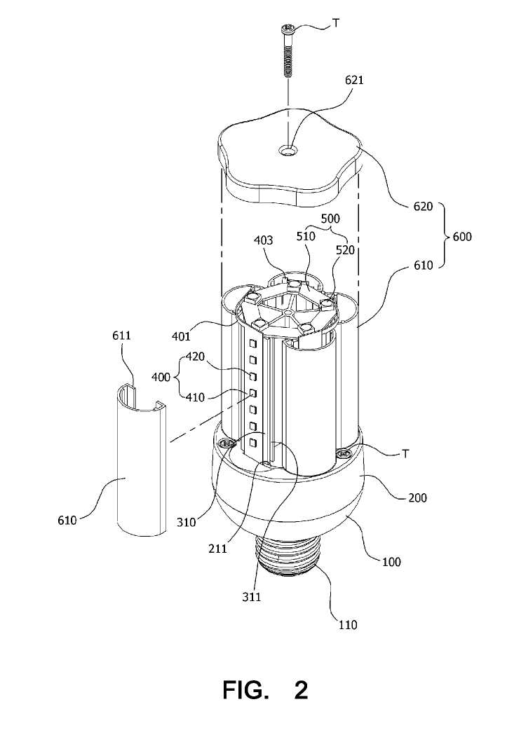

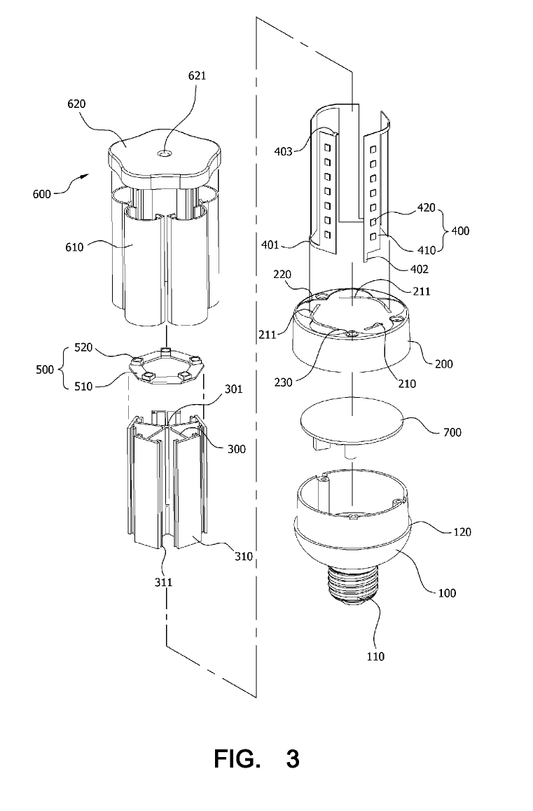

The case body heat sink 200 is formed in a hollow pipe shape which is opened at one end thereof, and the power case body 100 has a circumferential engagement step 120 formed on the outer peripheral surface thereof to allow the inner peripheral surface of the case body heat sink to be contactingly engaged with the outer peripheral surface of the power case body 100 so that the body heat sink 200 partially encircles the outer peripheral surface of the power case body 100 as shown in FIG. 3. In this case, the engagement method between the case body heat sink 200 and the power case body 100 may be implemented in a fit engagement manner or a screw engagement manner through screw holes 2340 as shown in FIGS. 2 and 3, but may be various engagement methods can be implemented within a range of ensuring a firm engagement between the case body heat sink 200 and the power case body 100. By virtue of this configuration, a contact area between the case body heat sink 200 and external air is increased and thus release of heat transferred from the lamp heat sink 300, which will be described, to the outside can be more effectively performed.

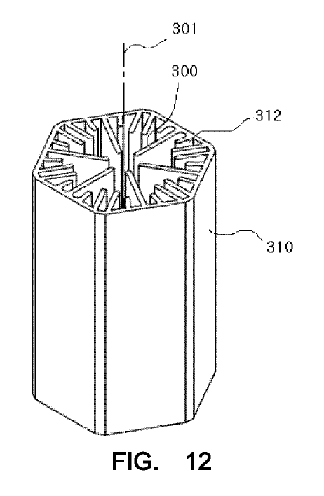

The lamp heat sink 300 is protrudingly coupled to the case body heat sink 200 in a contactable manner so as to be thermally conducted with the case body heat sink 200. In this embodiment, the lamp heat sink 300 is protrudingly coupled to one surface or one side of the case body heat sink 200 in a contactable manner so as to be thermally conducted with the case body heat sink 200. In this case, the lamp heat sink 300 may have such a structure as to be provided in plural numbers to form a radial structure with respect to a central axis 301 formed in a direction where the lamp heat sink 300 is protruded from the case body heat sink 200. In other words, the lamp heat sinks 300 can be formed in a rectangular flat plate shape as shown in FIGS. 2 and 3, and are contactingly coupled at one ends thereof to one surface of the case body heat sink 200 in a longitudinal direction thereof. In addition, the plurality of lamp heat sinks 300 are coupled at one ends thereof to the central axis 301 in a transverse direction thereof in such a manner as to arranged in a radial shape with respect to the central axis 301. In this case, the plurality of lamp heat sinks 300 may be arranged in a radial shape with respect to a virtual central axis in a state in which they are not coupled to the central axis 301 (see FIG. 12). Further, the lamp heat sink 300 may be configured in various manners within a range of effectively externally releasing heat generated from the main LED module which will be described later, by taking such a structure as to achieve heat transfer through the contact between the lamp heat sink and the case body heat sink, such as taking a structure in which a plurality of simple rectangular flat plates are contactingly coupled to one surface of the case body heat sink in such a manner as to be raidally arranged spaced apart from each other at equal distances.

The LED module 400/500 includes one or more LEDs, which externally emit light in response to an electric signal applied thereto. The LED module 400/500 includes a main LED module 400, and may include an auxiliary LED module 500, if necessary. The main LED module 400 and/or the auxiliary LED module 500 may be modified variously depending on design specifications, such as taking a structure in which main LED module 400 and/or the auxiliary LED module 500 is/are provided in single number or plural numbers.

A main LED module 400 is contactingly coupled to each of the outer ends of the lamp heat sinks 300 so that heat generated from the main LED module 400 is conducted through the lamp heat sink 300. In this case, the lamp heat sink 300 may include a flat-shaped contact plate 310 arranged at the outer end thereof in a radial direction so as to allow the main LED module 400 to be coupled to the contact plate 310 while being surface-contacted with the contact plate 310. By virtue of this configuration, a contact area between the lamp heat sink 300 and the main LED module 400 is increased, and thus thermal conductivity therebetween is improved, thereby enhancing the heat dissipation effect. In this case, the contact plate 310 arranged in a radial shape with respect to the central axis of the lamp heat sink 300 may be configured differently in number depending on an intention of a designer.

The main LED module 400 is coupled to each of the outer ends of the lamp heat sinks 300 and receives power supplied thereto from the outside through the lamp terminal 110 of the power case body 100 to emit light. In this case, each main LED module 400 is arranged to emit light in a radial direction outwardly from the central axis 310 so that light can be emitted in all directions with respect to the central axis 301. The main LED module 400 includes a main LED board 410 and a plurality of main LED lamps 420 mounted on the main LED board 410. The main LED board 410 is formed in a flat plate shape. The main LED board 410 is configured such that it is coupled at one side thereof to the contact plate 310 of the lamp heat sink 300 while being surface-contacted with the contact plate 310 and a plurality of main LED lamps 420 are aligned on the other side of the main LED board 410.

By virtue of this configuration, the LED lighting device according to one embodiment of the present invention enables the main LED module 400 mounted in a radial direction to the outer end of the lamp heat sink 300 to emit light in all direction, and enables heat generated from the main LED module 400 to be transferred to the lamp heat sink 300 and then the case body heat sink 200. The case body heat sink 200 is disposed so as to be exposed to the outside so that since a contact area between the case body heat sink 200 and the external air is increased, an external dissipation effect of heat transferred to the case body heat sink 200 from the lamp heat sink 300 is excellent.

In this case, the lamp heat sink 300 is provided in plural numbers such that plural lamp heat sinks 300 are arranged to form a radial structure and the main LED module 400 is mounted to each of the lamp heat sinks 300. Thus, heat generated from each main LED module 400 is efficiently uniformly transferred to the lamp heat sink 300. Further, a contact area between the lamp heat sink 300 and the case body heat sink 200 is also increased by virtue of the radial structure of the lamp heat sink 300, so that thermal conductivity of heat transferred to the case body heat sink 200 from the lamp heat sink 300 is excellent. Thus, heat generated from the main LED module 400 does not stay in the internal space of the LED lighting device but is effectively transferred to the lamp heat sink 300 and the case body heat sink 200 so that heat dissipation capacity of the LED lighting device through the case body heat sink 200 is further improved. In the meantime, since the lamp heat sink 300 is provided in plural numbers such that plural lamp heat sinks 300 are arranged to form a radial structure as described above, the entire contact area between the lamp heat sink 300 and the external air is increased and thus the heat dissipation effect of the lamp heat sink 300 is excellent. Thus, an additional heat dissipation function is exhibited besides the heat dissipation function through the thermal conduction scheme using the case body heat sink 200. Such an LED lighting device the LED module may include an auxiliary LED module 500 contactingly coupled to a protruded top end of the lamp heat sink 300 so as to be thermally conducted with the lamp heat sink as shown in FIGS. 2 and 3. At this time, the auxiliary LED module 500 is electrically connected with the main LED module 400 so that it receives power supplied from the outside through the lamp terminal 110 to emit light in a direction in which the lamp heat sink 300 is protruded from the case body heat sink 200. Thus, the LED lighting device according to one embodiment of the present invention is configured such that light is emitted in all radial directions by the main LED module 400 and simultaneously in a direction perpendicular to the radial directions, i.e., in a direction of the central axis 301. The auxiliary LED module 500 may include an auxiliary LED board 510 contactingly couple to a top end of the lamp heat sink 300 and a plurality of auxiliary LED lamps 520 mounted onj the auxiliary LED board 510. In this case, the auxiliary LED board 510 is preferably formed in a circular, annular, or polygonal plate shape so as to be contactingly coupled to the outer periphery of the protruded top end of the lamp heat sink 300. Thus, heat generated from the auxiliary LED module 500 is conducted to the lamp heat sink 300 smoothly as well as the central side of the lamp heat sink 300 is not blocked by the auxiliary LED board 510 to cause air to be ventilated so that the heat dissipation function of the lamp heat sink 300 can be maintained well.

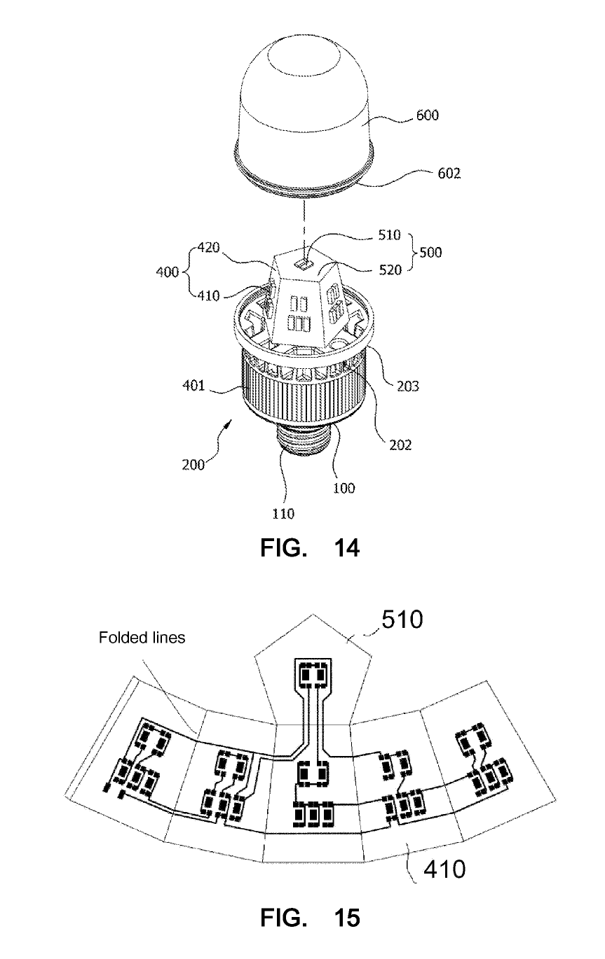

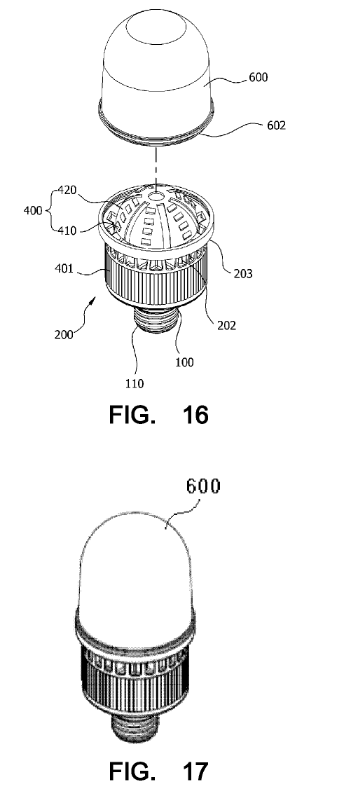

Meanwhile, the electrical connection between the main LED module and the auxiliary LED module can be established in various manners. The main LED module and the auxiliary LED module may take such a structure as to be formed as independent boards that are separated from each other and are electrically connected to each other as shown in FIGS. 1 to 11, and may take such a structure as to be formed integrally with each other using a single board as shown in FIGS. 14 and 15. In addition, the connection structure between the main LED module and the auxiliary LED module may be modified variously depending on design specifications, such as taking a structure in which a plurality of main LED modules are connected to each other and then an auxiliary LED module is connected to any one of the main LED modules or a structure in which a plurality of main LED modules are connected to each other with respect to an auxiliary LED module. Moreover, in the case where the main LED module and the auxiliary LED module are formed integrally with each other, the connection structure between the main LED module and the auxiliary LED module may be modified variously depending on design specifications, such as taking a structure in which an auxiliary LED module is connected to any one of a plurality of main LED modules which are connected to each other as shown in FIG. 15 and an auxiliary LED module is connected to any one main LED module of both ends. The main LED module and the auxiliary LED module, which will be described later, include the main LED board and the main LED lamps, and the auxiliary LED board and the auxiliary LED lamps, respectively. The main LED board and/or the auxiliary LED board may be configured in various manners, such as including any one of a typical FR4 printed circuit board, a flexible printed circuit board, a highly thermal conductive printed circuit board, a metal printed circuit board.

In addition, the LED lighting device according to one embodiment of the present invention may include a light guide cap 600 configured to encircle the outside surfaces of the main LED module 400 and the auxiliary LED module 500 as shown in FIG. 1.

The light guide cap 600 may be modified variously, such as being formed to be divided into a plurality of main light guide caps 610 configured to encircle the plurality of main LED modules 400 and an auxiliary light guide cap 620 configured to encircle the auxiliary LED module 500 or being formed as a single light guide cap 600 configured to wholly encircle the main LED module 400 and the auxiliary LED module 500. The light guide cap 600 employs diffusion of light so as to prevent a glare phenomenon due to straightness and high brightness of the LED, and the detailed description of the structure and function of the light guide cap 600 will be made later.

Hereinafter, the detailed configuration of the LED lighting device according to one embodiment of the present invention will be described in more detail.

The main LED module 400 is configured to be coupled to the contact plate 310 of each of the plurality of lamp heat sinks 300 while being surface-contacted with the contact plate 310, and to receive power through the lamp terminal 110 of the power case body 100. In this case, the main LED module 400 can be configured to be connected to the lamp terminal 110 through a separate electric wire, but the LED lighting device according to one embodiment of the present invention may be configured as a structure in which a separate power supplying drive board 700 is mounted in an internal space of the power case body 100.

In other words, the drive board 700 electrically connected to the lamp terminal 110 is mounted in the internal space of the power case body 100, and the main LED module 400 is electrically connected to the drive board 700. In this case, a separate SMPS 710 is mounted on the drive board 700 so as to be electrically connected to the lamp terminal 110 as shown in FIG. 4.

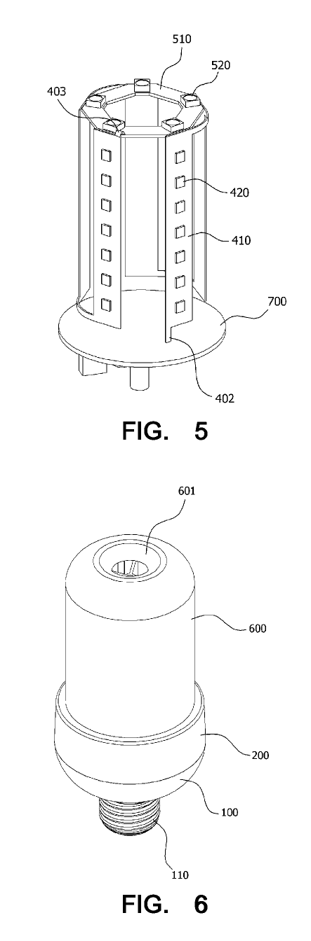

In addition, each of the plurality of main LED modules 400 may be configured to be connected to the drive board 700, but may be configured such that the plurality of main LED modules 400 are electrically connected to each other and then only any one of them is connected to the drive board 700 as shown in FIG. 5. That is, the main LED modules 410 of the main LED modules 400 are configured such that the main LED boards arranged adjacent to each other are sequentially connected to each other through a plurality of connection parts 401 formed as a flexible printed circuit board. A main contact 4012 is formed at a bottom end of a first main LED board 410 of sequentially connected main LED boards 410.

In this case, the main contact 402 may also be formed as a flexible printed circuit board, but is configured such that is coupled to the drive board 700 and power is supplied to the first main LED board 410 through the main contact 402. Thus, power is supplied to the first main LED board 410 from the drive board 700 through the main contact 402, and then is supplied to all the main LED boards 410 through the connection parts 401.

In addition, an auxiliary contact 403 is formed at a top end of a last one of the thus sequentially connected main LED boards 410. The auxiliary contact 403 is formed as a flexible printed circuit board so as to be connected to the auxiliary LED board 510 of the auxiliary LED module 500 positioned above the main LED module 400. By virtue of this configuration, the plurality of main LED boards 410 and the auxiliary LED board 510 are electrically connected to each other in a sequential connection manner. Thus, power supplied to the first main LED board 410 from the drive board 700 through the main contact 402 is sequentially applied to the plurality of main LED boards 410, and then is applied to the auxiliary LED board 510.

By virtue of this configuration, since the plurality of main LED boards 410 are electrically connected to the drive board 700 through a single connection point, they need not to be all connected, which makes it easy to manufacture and assemble the LED lighting device. In addition, since a pattern circuit formed on the board is also formed in a more simple shape, including the auxiliary LED board 510, the boards are easy to manufacture and are connected to each other using a single line so that they can be more effectively controlled.

The main LED boards 410 and/or the auxiliary LED board 510 as described above can be formed as a typical printed circuit board, and may be formed as a flexible printed circuit board or a highly thermal conductive printed circuit board besides the typical printed circuit board. In particular, according to one embodiment of the present invention, the main LED boards 410 and/or the auxiliary LED board 510 may be formed as a metal printed circuit board in order to facilitate the release of heat through rapid diffusion of heat. In this case, a separate cooling fin (not shown) may be mounted on a rear surface of each board for the purpose of more effective release of heat. As such, even in the case where the main LED boards 410 is formed as the metal printed circuit boards, the connection parts 401, the main contact 402 and the auxiliary contact 403 may be formed as the flexible printed circuit board or the highly thermal conductive flexible printed circuit board.

In addition, the main LED module 400 may be configured such that a number of main LED boards 410 are electrically connected to each other to form a single main LED module 400 and each of the main LED boards 410 may be configured such that it is electrically to the auxiliary LED board 510 to form a single LED module.

Further, in the case where the main LED boards 410 and the auxiliary LED board 510 are formed the flexible printed circuit board (FPCB) or the highly thermal conductive flexible printed circuit board (FPCB), they may be formed integrally with each other and power supplied through the power supplying drive board 700 may be first applied to the main LED module or the auxiliary LED module.

Moreover, the power supplying drive board 700 may be first connected to the main LED modules, a first or intermediate main LED module may be connected to the auxiliary LED module, and the auxiliary LED module may be connected to the remaining main LED modules.

In the meantime, since the main LED boards 410 are connected to the drive board 700 disposed inside the power case body 100, the case body heat sink 200 coupled to the opened end of the power case body 100 has a through-hole 210 formed thereon so as to allow the main LED board 410 to pass therethrough. In this case, one through-hole 210 may be formed so that the main contact 402 can pass through the through-hole 210 as described above. On the other hand, the case body heat sink 200 may additionally have separate through-holes 211 formed thereon so that the main LED boards 410 and the connection parts 401 interconnecting the main LED boards 410 can pass through the separate through-holes 211 as shown in FIG. 3. In this case, the through-holes 210 and 211 may be formed so as to be brought into close contact with the main LED boards 410 so that heat generated from the main LED boards 410 can be directly conducted to the case body heat sink 200.

In addition, the case body heat sink 200 is configured such that heat generated from lamp heat sink 300 is conducted and dissipated to the outside as described above. For the purpose of smooth conduction and dissipation of heat, the case body heat sink 200 is preferably formed of a metal material, for example, an aluminum die casting material. Moreover, although it has been described that the lamp heat sink 300 and the case body heat sink 200 are formed separately so as to be contactingly coupled to each other, the lamp heat sink 300 and the case body heat sink 200 may be formed integrally formed with each other. By virtue of this configuration, the LED lighting device may take a structure in which heat dissipated from the LED module, i.e., the main LED module and/or the auxiliary LED module is smoothly transferred to the case body heat sink through the lamp heat sink so that an efficient heat dissipation structure is implemented to maximize the heat dissipation capacity.

That is, the lamp heat sink 300 may be configured such that it is also formed of an aluminum die casting material so as to be formed integrally with the case body heat sink 200. Besides, the case body heat sink 200 and/or the lamp heat sink 300 may be formed of various materials selected within a range of ensuring excellent thermal conductivity to implement a heat dissipation structure for efficient heat dissipation, such as magnesium, a aluminum magnesium alloy material, a highly thermal conductive alloy or metal, or a highly thermal conductive resin, which is excellent in heat conduction and dissipation effect.

In the meantime, as described above, the light guide cap 600 is configured to encircle the outer surfaces of the main LED modules 400 and the auxiliary LED module 500 to complement straightness and high brightness of light by the LED. The light guide cap 600 may serve to diffuse light exiting the LED module with uniform luminance to uniformly output light to the outside. That is, the light guide cap 600 is disposed extending from one surface of the case body heat sink to take the same longitudinal structure as that of the lamp heat sink, and the lamp heat sink is disposed inside the light guide cap 600 so that light existing the LED module connected to the lamp heat sink is irradiated in a radial direction with respect to the longitudinal central axis of the lamp heat sink to allow light of uniform luminance to exit the lamp heat sink through the light guide cap. By virtue of this longitudinal structure of the light guide cap 600, the radial dissipation structure of light can be smoothly implemented. Although it has been illustrated in this embodiment that the longitudinal structure which the light guide cap and the lamp heat sink has a structural ratio in which a ratio of a longitudinal length of the lamp heat sink and a radial distance to the lamp heat sink from the longitudinal central axis of the lamp heat sink is more than 1, the longitudinal structure ratio can be selected in various manners depending on the design specifications.

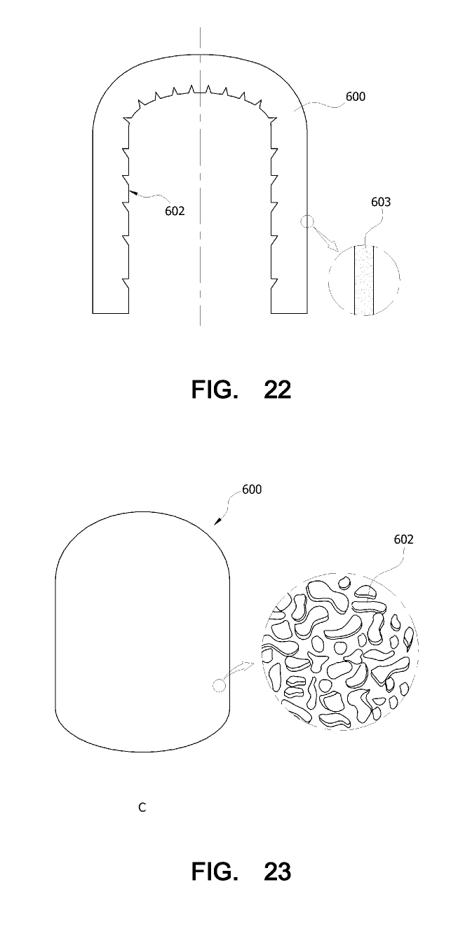

According to one embodiment of the present invention, the light guide cap 600 preferably has light guide projections (not shown) formed on an inner surface and/or an outer surface thereof so that light emitted from the main LED modules 400 and the auxiliary LED module 500 can be diffused with uniform luminance. The light guide projections may be formed in the shape of concavo-convex portions arranged spaced apart from each other at regular intervals in the longitudinal and transverse directions to form a light guide surface diffusing unit. By virtue of this configuration, the light guide cap 600 may be formed in various manners so that light passing through the light guide cap 600 can be refracted and diffused. As shown in FIGS. 21 and 22, the light guide cap 600 has a light guide surface diffusing unit 602 formed on an inner surface or an outer surface thereof to form a concavo-convex structure so that light emitted from the main LED modules or the auxiliary LED module can be smoothly irradiated to the outside.

In addition, a light guide surface diffusing unit having a non-formulaic pattern may be formed besides the light guide surface diffusing unit having a formulaic pattern, if necessary. That is, as shown in FIG. 23, the light guide cap 600 may have a light guide surface diffusing unit 602 with a non-formulaic pattern formed on an inner surface or an outer surface thereof so that uniform diffusion of light emitted from the main LED modules or the auxiliary LED module can be performed. The light guide surface diffusing unit 602 is formed with projections of an irregular pattern using sand blasting. The light guide cap 600 may be configured such that a light guide surface diffusing unit of an irregularly projected pattern is formed on the inner surface and/or the outer surface of the light guide cap by performing a chemical corrosion or sand blasting process in a mold for producing the light guide cap 600.

Ths light guide cap 600 can be formed to be divided into a plurality of main light guide caps 610 that encircle the outer surfaces of the main LED modules 400 and an auxiliary light guide cap 620 as shown in FIGS. 1 and 2. The plurality of main light guide caps 610 and the auxiliary light guide cap 620 may be configured so as to be engaged with each other in a fit engagement manner. In other words, the auxiliary light guide cap 620 is configured to encircle the front portion of the auxiliary LED module 500 in a light emitting direction and have a screw hole 621 formed at a center thereof so that a screw is engaged to the central axis 310 of the lamp heat sink 300 therethrough. The main light guide cap 610 is configured to be fitted at one end thereof into the outer peripheral edge of the auxiliary light guide cap 620 and to encircle the front portion of the main LED module 400 in a light emitting direction. In this case, a seating step 220 may be formed on one surface of the case body heat sink 200 on which the main light guide caps 610 are seated so that the main light guide caps 610 are stably supported thereon.

Meanwhile, each of the main light guide caps 610 may be configured to have having a certain length and formed in a semi-circular shape in cross-section as shown in FIG. 2. The main light guide cap 610 may have engagement protrusions 611 protrudingly formed inwardly from both ends of a portion forming a semi-circle. The contact plate 310 of the lamp heat sink 300 has insertion grooves 311 formed on both lateral sides there to correspond to the engagement protrusions 611 so that the engagement protrusions 611 are inserted into the insertion grooves 311. The main light guide cap 610 can be fixedly coupled to the lamp heat sink 300 through the engagement between the engagement protrusion 611 and the insertion groove 311.

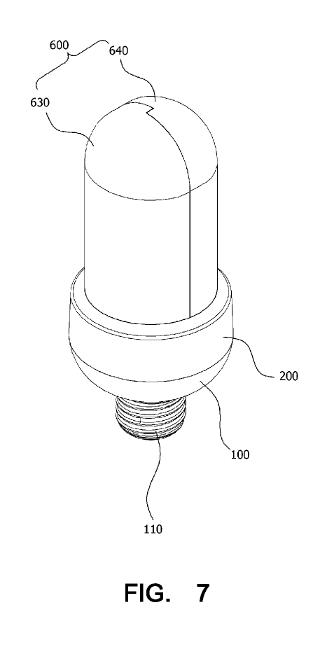

Although there has been described a structure in which the light guide cap 600 is formed to include the main light guide caps 610 and the auxiliary light guide cap 620 that are separated from each other, the light guide cap 600 may be formed in an integral shape which wholly encircles the outer surfaces of the main LED modules 400 and the auxiliary LED module 500 as shown in FIGS. 6, 7 and 8. In this case, as shown in FIG. 6, the light guide cap 600 may has a ventilation hole 601 formed at a center of the top portion thereof so that external air can be ventilated to the central portion of the lamp heat sink 300. By virtue of this ventilation hole 601, the heat dissipation function of the lamp heat sink 300 can be maintained smoothly. Even in this case, the ventilation hole 601 is preferably formed in a concavely depressed shape so as to come into close contact with the lamp heat sink 300 to prevent light emitted from the auxiliary LED module 500 from directly being dissipated to the outside through the ventilation hole.

In the meantime, as shown in FIG. 7, the light guide cap 600 may be configured in a shape which is hermetically sealed to encircle the outer surfaces of the main LED modules 400 and the auxiliary LED module 500. In this case, the light guide cap 600 may be formed to be divided into a front light guide cap 630 and a rear light guide cap 640 that are disposed at both sides thereof along the longitudinal direction thereof. By virtue of this divided structure, the light guide cap 600 is easily mounted to the case body heat sink 200 and may be used in a state in which any one of the front light guide cap 630 and the rear light guide cap 640 is removed, if necessary.

Meanwhile, as shown in FIGS. 6 and 7, in the case where the light guide cap 600 is formed in an integral shape which wholly encircles the outer surfaces of the main LED modules 400 and the auxiliary LED module 500, it may be fixedly engaged to the case body heat sink 200 in a screw engagement manner, may be fixedly engaged to the case body heat sink 200 in a fit engagement manner, or may fixedly screwed to the case body heat sink 200 using a screw. In addition, the engagement structure of the light guide cap may be modified in various manners depending on the design specifications within a range of preventing the light guide cap from being unintentionally separated from the case body heat sink, such as taking a structure in which a lower end of the light guide cap is formed in a clip shape so as to be clip-fastened to the case body heat sink.

The light guide cap may be modified in various manners, such as taking a structure in which the main light guide caps and the auxiliary light guide cap are formed separately from each other or a structure in which the main light guide caps and the auxiliary light guide cap are formed integrally with each other to wholly encircle the main LED modules and the auxiliary LED module. In addition, the light guide cap may take such a structure as to be opened at a lower end thereof so as to be engaged to the case body heat sink and/or the power case body, and the other end of the light guide cap may be selectively modified in various manners. That is, the light guide cap may be modified variously depending on design specifications, such as being formed in a hollow shape which has a ventilation hole formed at a center of the other end thereof, being formed in a flat cylindrical barrel shape at an end thereof, being formed in a dome-like cylindrical barrel shape at an end thereof, and being formed in a hemi-spherical shape.

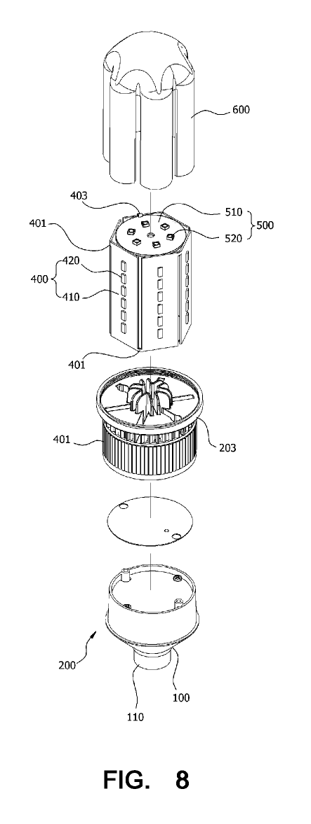

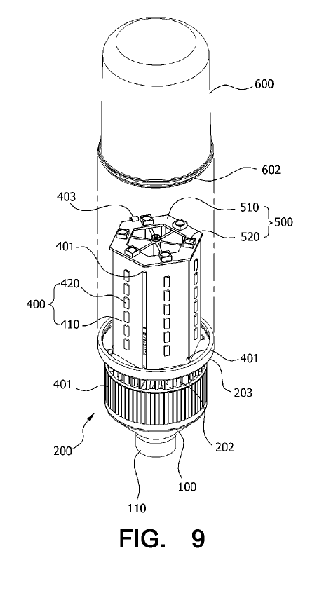

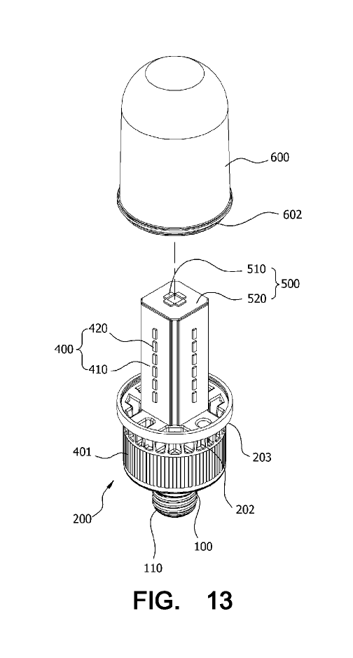

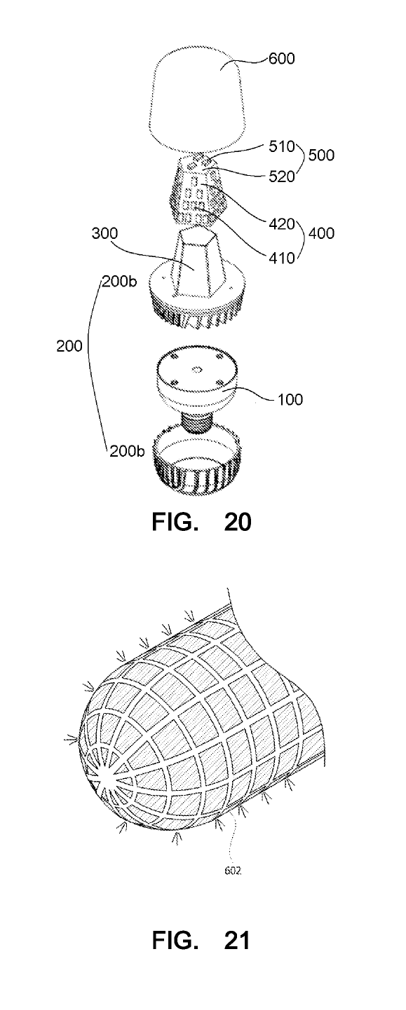

For example, as shown in FIG. 8, the light guide cap 600 may be formed in a shape which encircles the outer surface of each of the main LED modules separately and is partially opened between adjacent main LED modules at a side thereof in a vertical direction thereof. By virtue of this configuration, external air is ventilated through the central portion of the light guide cap 600 so that the heat dissipation capacity of heat generated from the LED by the lamp heat sink 300 can be improved. In addition, the light guide cap 600 may be modified in various manners depending on the design specifications, such as taking a structure in which a top thereof forms a flat structure and a peripheral edge of the top surface thereof is chamfered as shown in FIG. 9, taking a structure in which a plurality of main light guide caps are arranged to separately encircle the main LED modules and are integrally formed at the top thereof with a separate auxiliary light guide cap as shown in FIG. 8, taking a cylindrical barrel structure in which it is formed in a dome shape at a top thereof, whose top surface is flat, and it has a longitudinal length as shown in FIG. 13, taking a structure in which it is formed in a hemi-spherical shape having a dome-like end and a short length as shown in FIG. 14, and taking a structure in which it is formed in a dome shape at a top thereof as shown in FIGS. 17 to 20.

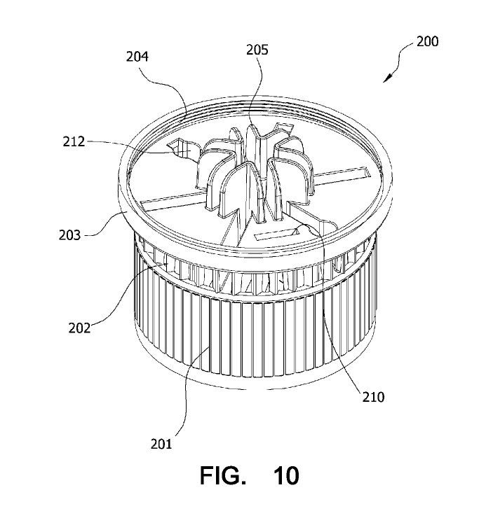

FIG. 9 is a partially exploded perspective view illustrating the inner coupled state of an LED lighting device according to another embodiment of the present invention, and FIG. 10 is a schematic perspective view illustrating a case body heat sink of an LED lighting device according to another embodiment of the present invention.

The LED lighting device according to another embodiment of the present invention is configured such that the case body heat sink 200 has a heat dissipation wing unit 202 formed therein to strengthen the heat dissipation function as shown in FIGS. 9 and 10. That is, the case body heat sink 200 is configured to include an engagement unit 201 engaged to the opened one end of the power case body 100 in such a manner as to partially encircle the outer peripheral surface of the power case body 100, a support unit 203 disposed above the engagement unit 201 so as to be spaced apart from the engagement unit 201, and a heat dissipation wing unit 202 arranged between the engagement unit 201 and the support unit 203 as shown in FIG. 10. In this case, the support unit 203 may include a separate support guide 205 formed at the central portion of a top surface thereof so as to allow the lamp heat sink 300 to be seatingly supported thereon. In addition, the support unit 203 may include a though-hole 210 formed at one side of the top surface thereof so as to allow the main LED board 410 to pass therethrough. Further, the support unit 203 has a female screw thread 204 formed on the inner peripheral surface thereof so as to allow the light guide cap 600 to be screwably engaged with the female screw thread 204. The light guide cap 600 has a male screw thread 602 formed on the outer peripheral surface of a lower end thereof to correspond to the female screw thread 204. The light guide cap 600 may be implemented as a single integral structure to wholly encircle the main LED module 400 and the auxiliary LED module 500. The structure of the light guide cap 600 may be modified variously in the same manner as described above, and the engagement structure of light guide cap 600 may also be modified in various manners such as a fit engagement manner besides a screw engagement manner.

The heat dissipation wing unit 202 may be formed in a shape in which a plurality of flat wings are circumferentially arranged between the engagement unit 201 and the support unit 203 as shown in FIG. 10. Preferably, the flat wings are arranged spaced apart from each other at regular intervals to form air flow passages between the flat wings so that external air flows into and out of the case body heat sink and smooth air flow is produced. Thus, the case body heat sink 200 further improves the heat dissipation capacity due to an increase in the contact area and time with the external air by virtue of the heat dissipation wing unit 202.

In addition, the case body heat sink 200 may include a ventilation port 212 formed thereon in such a manner as to pass through the bottom surface thereof and fluidically communicate with lateral holes of the dissipation wing unit 202 so that heat generated inside the light guide cap 600 positioned above the case body heat sink 200 can be released to the outside. The ventilation port 212 serves as a fluid passage which prevents heat emitted from the LED module from being captured inside the light guide cap 600 to allow the heat to be released to the outside. Simultaneously, the ventilation port 212 increases the contact area between the heat dissipation wing unit 202 of the case body heat sink 200 and the external air, thereby further improving the heat dissipation capacity.

The configuration and operation principle of the LED lighting device shown in FIGS. 9 and 10 is the same as that the LED lighting device shown in FIGS. 1 to 7 except the case body heat sink 200 as described above, and thys the detailed description thereof will be omitted to avoid redundancy.

In the meantime, the lamp heat sink 300 is formed as a radial structure. The lamp heat sink 300 may be configured to form a radial structure with respect to the central axis 301 as shown in FIG. 3, and its detailed structure may be modified in various manners.

The lamp heat sink 300 may be formed in a single polygonal block shape in which respective contact plates 310 are consecutively connected to each other in a state of not being coupled to the central axis 301 and are formed with a plurality of heat dissipation wings 312 protruded radially inwardly from the inner surfaces thereof as shown in FIG. 12. In FIG. 13, the number of the contact plates 310 is four and the number of the contact plates 310 formed in a radia structure as formed in a quadrangular shape may be set variously depending on an intention of a designer. That is, the lamp heat sink 300 takes a structure in which the main LED lamps of the main LED modules are arranged on the lamp heat sink 300 so as to be oriented outwardly from the center of the LED lighting device, and may be implemented in various shapes within a range of achieving heat transfer through the contact with the main LED board on which the main LED lamps are arranged.

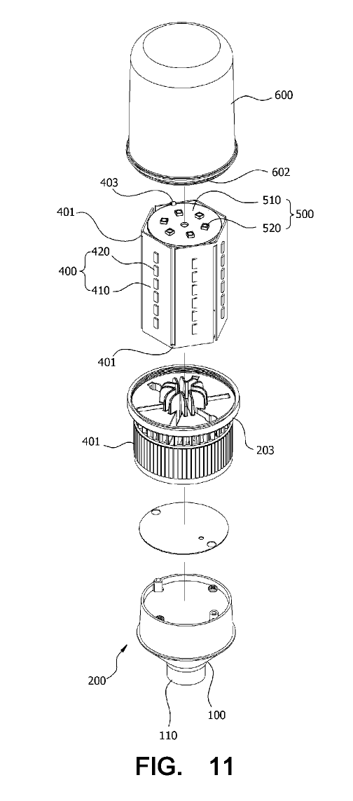

FIG. 11 is an exploded perspective view illustrating an LED lighting device according to another embodiment of the present invention, and FIG. 12 is a schematic perspective view illustrating a lamp heat sink 300 of an LED lighting device according to another embodiment of the present invention.

In FIGS. 11 and 12, the lamp heat sink 300 can be formed in a radial structure in which it includes a plurality of contact plates 310 consecutively connected to each other and a plurality of heat dissipation wings radially arranged so as to be oriented toward the center thereof.

FIG. 13 is a partially exploded perspective view schematically illustrating an LED lighting device according to another embodiment of the present invention.

The lamp heat sink 300 may be formed in a radial shape in which four contact plates 310 are consecutively connected to each other and the heat dissipation wings are radially arranged so as to be oriented toward the center thereof.

FIG. 14 is a partially exploded perspective view schematically illustrating an LED lighting device according to another embodiment of the present invention.

The lamp heat sink 300 may be formed in a conical radial shape in which the contact plates 310 are consecutively connected to each other and the heat dissipation wings are arranged so as to be oriented downwardly.

FIG. 15 is a developed view schematically illustrating an integral type LED module structure in which the main LED module and the auxiliary LED module are formed integrally with each other using a flexible printed circuit board (FPCB) coupled to the conical lamp heat sink 300 of FIG. 14.

In FIG. 15, the integral type LED module may be modified in various manners such as being implemented as a flexible printed circuit board and a highly thermal conductive flexible printed circuit board (FPCB).

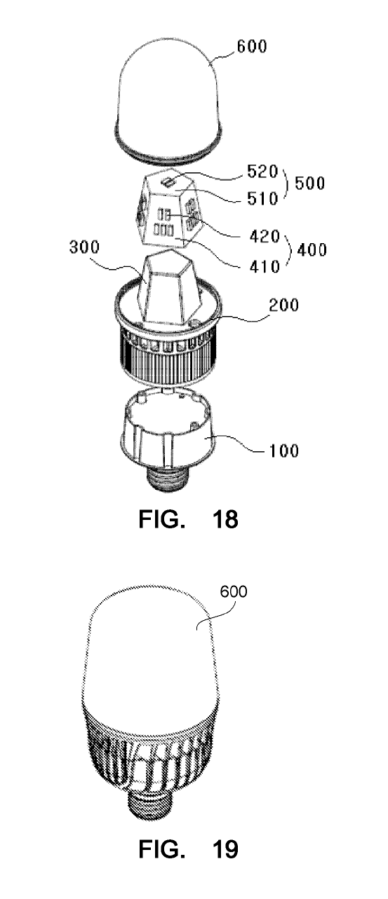

FIG. 16 is a partially exploded perspective view schematically illustrating an LED lighting device according to another embodiment of the present invention.

The lamp heat sink 300 may be formed in a spherical radial shape in which the contact plates 310 are consecutively connected to each other and the heat dissipation wings are arranged so as to be oriented downwardly.

In the meantime, although it has been described in the above embodiments that the case body heat sink is formed as a single unit, the case body heat sink according to the present invention may be configured in various manners within a range of taking such a structure as to be engaged to the opened one end of the power case body while partially encircling the outer peripheral surface of the power case body. That is, as shown in FIGS. 19 and 20, the case body heat sink 200 consists of two elements, i.e., a heat sink base 200a and a heat sink body 200b. The heat sink base 200a is implemented as a ring shape which is opened at both ends thereof such that the power case body 100 is insertingly accommodated in the heat sink base 200a to close the opened lower end of the heat sink base 200a. The heat sink body 200b is connected to an upper end of the heat sink base 200a so that it is contactingly disposed on the power case body 100 accommodated in the heat sink base 200a. That is, the heat sink body 200b is coupled at a lateral end thereof to the heat sink base 200a and is brought at the underside thereof into close contact with the power case body 100, so that heat generated from an element such as SMPS disposed on the power case body 100 can be transferred to the heat sink base 200a to achieve smooth dissipation of the heat to the outside. In addition, the heat sink base 200a has a structure in which an opened lower end thereof is smaller than an opened upper end thereof, if necessary, so that when the power case body 100 is inserted into the heat sink base 200a, it can be brought into close contact with the inner surface of the heat sink base 200a, thereby achieving a structure in which heat is directly conducted to the heat sink base 200a.

In addition, the lamp heat sink 300 can be disposed on the top of the heat sink body 200b. The lamp heat sink 300 may be modified in various manners depending on the design specifications, such as taking a separate structure in which it is formed separately with the heat sink body 200b.

The lamp heat sink 300 shown in FIGS. 19 and 20 is implemented as a polygonal block structure as shown in FIG. 14, and may be implemented in a hollow shape.

In the meantime, the light guide cap can be made of any one of PC, acryl, nylon, PE, PEEK (Polyetheretherketone), and Transparent PET resins, so that heat resistance, insulation property, fire-retardancy and the like can be ensured, thereby preventing occurrence of a dangerous situation due to overheating and enabling safe use of the lighting device along with excellent light guide effect.

The light guide cap may further contain a light diffusion agent besides the above synthetic resin, i.e., a diffusion agent that diffuses light, if necessary. The diffusion agent may comprise a material such as calcium carbonate, calcium phosphate, or the like, and various materials may be selected as the diffusion agent within a range of performing a light diffusion function.

In addition, the light guide cap may take such a structure as to more smoothly dissipate heat generated from the inside of the lighting device to the outside, thereby improving the heat dissipation capacity. As enlargedly shown in FIG. 22, the light guide cap has a heat dissipation coating layer 603 formed on the outer surface thereof. The heat dissipation coating layer 603, which is a coating layer having a high heat transfer rate, is provided to perform smooth dissipation of heat generated from the inside of the lighting device. The heat dissipation coating layer 603 contains carbon nano tube (CNT), graphene, or ceramic. That is, the heat dissipation coating layer 603 containing any one of the above-mentioned materials is formed on the light guide cap so that heat generated from an internal element such as the main LED module, the auxiliary LED module, or SMPS can be more smoothly dissipated to the outside. In addition, although it has been described and illustrated in FIG. 23 that the heat dissipation coating layer is formed on the outer surface of the light guide cap, various modifications can be made such as taking a structure in which the heat dissipation coating layer is formed on the inner surface of the light guide cap.

Moreover, the light guide cap may be configured in various manners such as containing CNT, grapheme or ceramic as a filler based on the synthetic resin as described above, if necessary.

The embodiments as described above are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

### INDUSTRIAL APPLICABILITY

The LED lighting device according to the present invention can be used in a wide range of applications requiring an efficient illumination performance, such as vehicles, household appliances, industrial lights and public street lights.

1. An LED lighting device comprising:
a power case body opened at one end thereof to have an accommodation space defined therein and formed at the other end thereof with a lamp terminal;
a case body heat sink coupled to the opened one end of the power case body in such a manner as to partially encircle the outer peripheral surface of the power case body;
a lamp heat sink protrudingly coupled to the case body heat sink so as to be thermally conducted with the case body heat sink; and
an LED module contactingly coupled to the lamp heat sink so as to be thermally conducted with the lamp heat sink.

2. The LED lighting device according to claim 1, wherein the lamp heat sink is disposed to form a radial structure with respect to a central axis formed in a direction where the lamp heat sink is protruded from the case body heat sink, and the LED module comprises a main LED module contactingly coupled to the outer ends of the lamp heat sink so as to be thermally conducted with the lamp heat sink.

3. The LED lighting device according to claim 2, wherein the lamp heat sink comprises a contact plate arranged at the outer end thereof in a radial direction so as to allow the main LED module to be coupled to the contact plate while being surface-contacted with the contact plate.

4. The LED lighting device according to claim 3, wherein the contact plate has a heat dissipation wing protrudingly formed on the inner surface thereof.

5. The LED lighting device according to claim 2, wherein the LED module comprises an auxiliary LED module contactingly coupled to the lamp heat sink so as to be thermally conducted with the lamp heat sink, and the auxiliary LED module is electrically connected with the main LED module.

6. The LED lighting device according to claim 5, wherein the main LED module and the auxiliary LED module are formed integrally with each other using a single printed circuit board.

7. The LED lighting device according to claim 5, wherein the main LED module comprises a main LED board coupled to the contact plate of the lamp heat sink while being surface-contacted with the contact plate and one or more main LED lamps mounted on the main LED board.

8-14. (canceled)

15. The LED lighting device according to claim 1, wherein a separate power supplying drive board is mounted in an internal space of the power case body so as to be electrically connected to the lamp terminal, and the LED module is engaged with the drive board so as to be electrically connected to the drive board.

16. The LED lighting device according to claim 1, further comprising a light guide cap configured to encircle the outside surfaces of the lamp heat sink and the LED module.

17. The LED lighting device according to claim 5, wherein further comprising a light guide cap configured to encircle the outside surfaces of the main LED module and the auxiliary LED module.

18-24. (canceled)

25. The LED lighting device according to claim 1, wherein the case body heat sink and the lamp heat sink are formed of any one of aluminum, magnesium, aluminum magnesium alloy, highly thermal conductive alloy, and highly thermal conductive resin.

26. The LED lighting device according to claim 1, wherein the case body heat sink is formed integrally with the lamp heat sink so that heat generated from the LED module is conducted to the case body heat sink through the lamp heat sink to maximize the heat dissipation function.

27. The LED lighting device according to claim 1, wherein the case body heat sink comprises:
an engagement unit engaged to the power case body in such a manner as to partially encircle the outer peripheral surface of the power case body;
a support unit disposed above the engagement unit in such a manner as to be spaced apart from the engagement unit and configured to support the lamp heat sink; and
a heat dissipation wing unit arranged between the engagement unit and the support unit to improve the heat dissipation capacity.

28. The LED lighting device according to claim 1, further comprising a light guide cap configured to encircle the outer surfaces of the lamp heat sink and the LED module so the light emitted from the LED module can be diffused with uniform luminance, wherein the light guide cap is made of any one of PC, acryl, nylon, PE, PEEK, and transparent PET resins.

29. The LED lighting device according to claim 28, wherein the light guide cap further contains a diffusion agent.

30. The LED lighting device according to claim 28, wherein the light guide cap comprises a light guide surface diffusing unit formed on the inner or outer surface thereof so that light emitted from the main LED module and the auxiliary LED module can be diffused with uniform luminance.

31. The LED lighting device according to claim 1, further comprising a light guide cap configured to encircle the outer surfaces of the lamp heat sink and the LED module so that light emitted from the LED module can be diffused with uniform luminance, wherein the inner or outer surface of the light guide cap is coated with carbon nano tube (CNT), graphene, or ceramic to maximize a light dissipation function.

32. The LED lighting device according to claim 1, further comprising a light guide cap configured to encircle the outer surfaces of the lamp heat sink and the LED module so that light emitted from the LED module can be diffused with uniform luminance, wherein the light guide cap is made of any one of PC, acryl, nylon, PE, PEEK, and transparent PET resins, and is further filled with a carbon nano tube (CNT) filler, a grapheme filler or a ceramic filler to maximize a light dissipation function.

33. The LED lighting device according to claim 1, further comprising a light guide cap configured to encircle the outer surfaces of the lamp heat sink and the LED module so that light emitted from the LED module can be diffused with uniform luminance,
wherein the lamp heat sink has a longitudinal structure in which it is connected to the case body heat sink so as to extend from one surface of the case body heat sink, and
wherein the light guide cap has a longitudinal structure in which the light guide cap encircles the lamp heat sink in such a manner that the lamp heat sink is extendingly disposed inside the light guide cap.
